(19) United States
(12) Patent Application Publication
(10) Pub. No.: US 2024/0408899 A1
(43) Pub. Date: Dec. 12, 2024

(54) DRYER AND LIQUID DISCHARGE APPARATUS

(71) Applicants: Ryusaku HIDA, KANAGAWA (JP); Kohki ASADA, TOKYO (JP); Kazuaki KAMIHARA, TOKYO (JP); Kenji NOZAWA, KANAGAWA (JP); Genichiroh KAWAMICHI, KANAGAWA (JP); Takayuki SEKI, KANAGAWA (JP); Hiroki ISHIHARA, KANAGAWA (JP); Takehiro NAKAMURA, KANAGAWA (JP)

(72) Inventors: Ryusaku HIDA, KANAGAWA (JP); Kohki ASADA, TOKYO (JP); Kazuaki KAMIHARA, TOKYO (JP); Kenji NOZAWA, KANAGAWA (JP); Genichiroh KAWAMICHI, KANAGAWA (JP); Takayuki SEKI, KANAGAWA (JP); Hiroki ISHIHARA, KANAGAWA (JP); Takehiro NAKAMURA, KANAGAWA (JP)

(21) Appl. No.: 18/732,652

(22) Filed: Jun. 4, 2024

(30) Foreign Application Priority Data
Jun. 7, 2023 (JP) 2023-094035

(51) Int. Cl. B41J 11/00; B41J 13/08

(52) U.S. Cl. CPC B41J 11/0022; B41J 11/0085; B41J 13/08

(57) ABSTRACT

A dryer includes: a conveyor belt having a shape of an endless loop to convey a sheet in a conveyance direction; a drying unit facing an absorption surface of the conveyor belt to dry the sheet on the absorption surface; and an absorber including multiple suction members inside the endless loop of the conveyor belt, the suction members arrayed in the conveyance direction to absorb the sheet onto the absorption surface of the conveyor belt, and at least one suction member of the multiple suction members to generate a suction force different from suction forces of other suction members.

### CROSS-REFERENCE TO RELATED APPLICATIONS

This patent application is based on and claims priority pursuant to 35 U.S.C. § 119 (a) to Japanese Patent Application No. 2023-094035, filed on Jun. 7, 2023, in the Japan Patent Office, the entire disclosure of which is hereby incorporated by reference herein.

### BACKGROUND

### Technical Field

The present embodiment relates to a dryer and a liquid discharge apparatus.

### Related Art

A liquid discharge apparatuses includes an inkjet image-forming apparatuses to discharge ink onto sheets to form images on the sheets.

Some of such image-forming apparatuses include dryers to dry ink on sheets.

### SUMMARY

In an aspect of the present disclosure, a dryer includes: a conveyor belt having a shape of an endless loop to convey a sheet in a conveyance direction; a drying unit facing an absorption surface of the conveyor belt to dry the sheet on the absorption surface; and an absorber including multiple suction members inside the endless loop of the conveyor belt, the suction members arrayed in the conveyance direction to absorb the sheet onto the absorption surface of the conveyor belt, and at least one suction member of the multiple suction members to generate a suction force different from suction forces of other suction members.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a liquid discharge apparatus according to a first embodiment of the present embodiment;

FIG. 2 is a block diagram illustrating a configuration of a controller according to the first embodiment of the present embodiment;

FIG. 3 is a side view of a dryer according to the first embodiment of the present embodiment;

FIG. 4 is a plan view of the dryer according to the first embodiment of the present embodiment;

FIG. 5 is a diagram illustrating a configuration of a characteristic portion of the dryer according to the first embodiment of the present embodiment;

FIG. 6 is a diagram illustrating a configuration of a characteristic portion of a dryer according to a second embodiment of the present embodiment;

FIG. 7 is an aspect view in which a second suction member moves together with a downstream support roller;

FIG. 8 is a diagram used to explain a configuration of second suction members;

FIG. 9 is a diagram used to explain an arrangement of the second suction members and negative pressure generators;

FIG. 10 is a diagram illustrating a configuration of a characteristic portion of a dryer according to a third embodiment of the present embodiment;

FIG. 11A is a diagram used to explain a direction in which an air-blowing port faces;

FIG. 11B is another diagram used to explain the direction in which the air-blowing port faces;

FIG. 12 is a block diagram illustrating a configuration of a controller according to the third embodiment of the present embodiment;

FIG. 13 is a flowchart of an example of a control flow to control the volume of air;

FIG. 14 is a perspective view of an ultraviolet irradiator, which is an example of a drying unit; and

FIG. 15 is a diagram of a dryer according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, some embodiments will be described with reference to some accompanying drawings. Referring now to the drawings for use in explaining the embodiments, wherein like reference numerals designate identical or corresponding parts throughout the several views thereof, an image-forming apparatus according to an embodiment of the present disclosure is described below. In the following description, “image formation”, “recording”, and “printing” are all synonymous.

### [Configuration of Liquid Discharge Apparatus]

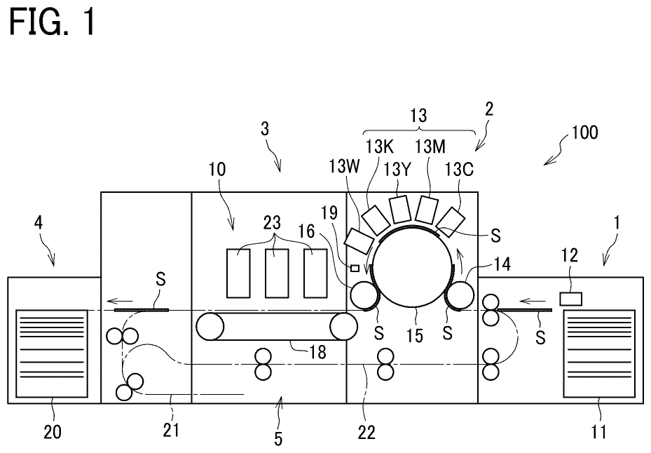

First, a configuration of a liquid discharge apparatus according to a first embodiment of the present embodiment will be described with reference to FIG. 1.

In FIG. 1, an inkjet image-forming apparatus is employed as an example of a liquid discharge apparatus 100 according to the first embodiment of the present embodiment. The liquid discharge apparatus 100 illustrated in FIG. 1 includes a sheet supply unit 1, an image former 2, a dryer 3, a sheet ejector 4, and a reverse conveyor 5.

The sheet supply unit 1 is a section that supplies a sheet S, which is a recording medium on which an image is to be formed. The sheet supply unit 1 includes: a supply tray 11 that can store multiple sheets S; and a feeding device 12 that separately and subsequently feeds the sheets S from the supply tray 11. When fed by the feeding device 12, the sheets S are supplied to the image former 2.

The image former 2 is a section that forms images on the sheets S. The image former 2 includes a liquid discharger 13, a first support rotator 14, a second support rotator 15, and a third support rotator 16. Each of the first support rotator 14, the second support rotator 15, and the third support rotator 16 is a rotator that rotates while supporting the sheet S on the outer peripheral surface thereof, thereby conveying the sheet S. When one of the sheet S is conveyed from the sheet supply unit 1, the sheet S is supported on the first support rotator 14 and then delivered to the second support rotator 15. When delivered to the second support rotator 15, the sheet S is further delivered from the second support rotator 15 to the third support rotator 16. The liquid discharger 13 includes multiple liquid discharge units 13C, 13M, 13Y, 13K, and 13W, each of which discharges a liquid ink onto the sheet S supported on the second support rotator 15. In the present embodiment, the liquid discharge unit 13C is provided for cyan ink; the liquid discharge unit 13M is provided for magenta ink; the liquid discharge unit 13Y is provided for yellow ink; the liquid discharge unit 13K is provided for black ink; and the liquid discharge unit 13W is provided for white ink. In addition, the liquid discharge units 13C, 13M, 13Y, 13K, and 13W are arranged in this order from the upstream side in the rotation direction of the second support rotator 15 (conveyance direction of the sheet S). The arrangement order of the liquid discharge units 13C, 13M, 13Y, 13K, and 13W does not have to be the same as the order illustrated in FIG. 1; the liquid discharge units 13C, 13M, 13Y, 13K, and 13W may be arranged in any order. Furthermore, the colors of the inks used for the individual liquid discharge units are not limited to cyan, magenta, yellow, black, and white. If necessary, liquid discharge units that discharge inks with other specific colors, such as white, gold, and silver, may be additionally provided.

When the sheet S is conveyed to a position facing the liquid discharge units 13C, 13M, 13Y, 13K, and 13W, the liquid discharge units 13C, 13M, 13Y, 13K, and 13W discharge the inks to the sheet S, thereby forming an image on the sheet S. The image formation does not necessarily have to be performed in a case where a full-color image is used with all of the liquid discharge units 13C, 13M, 13Y, 13K, and 13W and may also be performed in a case where a monochrome image is formed with one of the liquid discharge units 13C, 13M, 13Y, 13K, and 13W or a case where a two- or three-color image is formed with two or three image formers.

The dryer 3 is a section that dries the inks on the sheet S. The dryer 3 includes a drying device 10 including multiple drying units 23, a conveyor belt 18, a sheet detector 19, and some other components. Each of the drying units 23 is a section that dries the sheet S. In the present embodiment, each drying unit 23 is implemented by an ultraviolet irradiator that irradiates the sheet S being conveyed with ultraviolet rays. When the ink on the sheet S is irradiated with the ultraviolet rays, a coloring material, such as a pigment or a dye, contained in the inks absorbs the ultraviolet rays and converts this ultraviolet rays into thermal energy to generate heat. The head generated in this manner increases the temperature of the inks to evaporate water or an organic solvent contained in the inks, thereby drying the inks. Each drying unit 23 may be implemented by an infrared irradiator that irradiates the sheet S with infrared rays or a blower that blows out air to the sheet S. The sheet detector 19 detects the sheet S at a position upstream of the drying unit 23 in the conveyance direction (referred to below as the sheet conveyance direction) of the sheet S. In the present embodiment, the sheet detector 19 is disposed downstream of the liquid discharger 13 and upstream of the third support rotator 16 in the sheet conveyance direction. The sheet detector 19 is preferably implemented by a non-contact sensor, such as a reflective or transmissive sensor.

When the sheet S is conveyed to a position facing the drying units 23 by the conveyor belt 18, the drying units 23 subject the sheet S to a drying process. In the present embodiment, the ultraviolet irradiator irradiates the sheet S with ultraviolet rays, thereby drying the inks on the sheet S. The timing at which each ultraviolet irradiator irradiates the sheet S with the ultraviolet rays is determined based on both the timing at which the sheet detector 19 detects the sheet S and the conveyance speed of the sheet S.

The sheet ejector 4 is a section that ejects the sheet S. The sheet ejector 4 includes a discharge tray 20. When the sheet S is conveyed from the dryer 3 to the sheet ejector 4, the sheet ejector 4 ejects the sheet S to the discharge tray 20.

The reverse conveyor 5 is a section that flips the sheet S and then conveys the sheet S to the image former 2 again for the sake of double-sided printing. The reverse conveyor 5 includes a switchback conveyor 21 and a return conveyor 22. When the double-sided printing is performed, an image has already been formed on the first surface (front surface) of the sheet S in the image former 2 and subjected to the drying process in the dryer 3. The sheet S is then conveyed to the reverse conveyor 5 instead of being conveyed to the sheet ejector 4. After that, the sheet S is conveyed in the reverse direction by the switchback conveyor 21 in the reverse conveyor 5 and subsequently conveyed to the upstream side of the first support rotator 14 through the return conveyor 22. As a result, the sheet S is supplied to the image former 2 while being flipped. Then, an image is formed, by the image former 2, on a second surface (back surface) of the sheet S which is opposite to the first surface thereof. After that, the second surface is subjected to the drying process in the dryer 3. When the drying process is completed, the sheet S is conveyed to the sheet ejector 4.

### [Configuration of Controller]

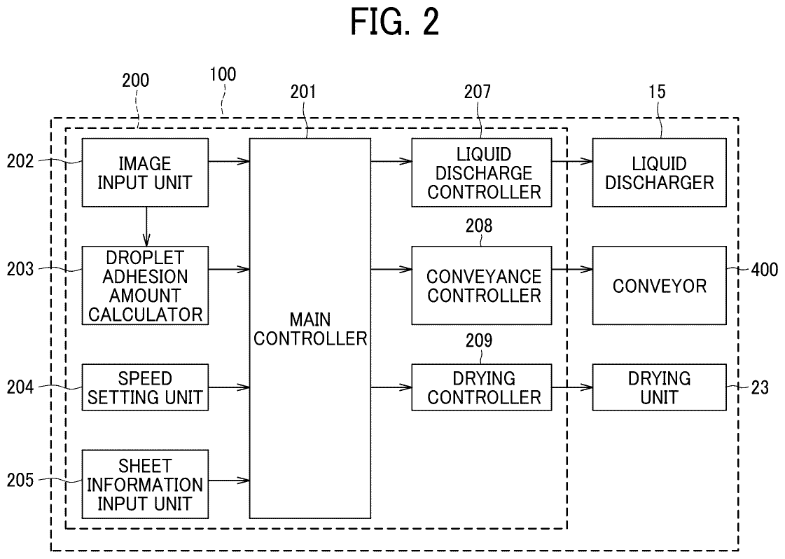

FIG. 2 is a block diagram illustrating a configuration of a controller according to the first embodiment of the present embodiment.

As illustrated in FIG. 2, the liquid discharge apparatus 100 includes a controller 200 that controls various operations, such as a sheet conveying operation, an image forming operation, and a drying operation. More specifically, the controller 200 includes a main controller 201, an image input unit 202, a droplet adhesion amount calculator 203, a speed setting unit 204, a sheet information input unit 205, a liquid discharge controller 207, a conveyance controller 208, and a drying controller 209.

The main controller 201 includes: a central processing unit (CPU) that controls an entire operation of the liquid discharge apparatus 100; a read only memory (ROM) that stores programs to be executed by the CPU and other fixed data items; a random access memory (RAM) that temporarily stores image information, a rewritable non-volatile random access memory (NVRAM) that retains data even while the power supply of the liquid discharge apparatus 100 is interrupted; and some other components.

When the speed setting unit 204 sets a conveyance speed of the sheet S, the main controller 201 transmits a control signal to the conveyance controller 208 based on information regarding the set speed. In response to the control signal from the main controller 201, the conveyance controller 208 controls a conveying operation of a conveyor 400. In this way, the sheet S is conveyed at the set speed. The conveyor 400 includes: the feeding device 12 in the sheet supply unit 1; the first support rotator 14, the second support rotator 15, and the third support rotator 16 in the image former 2; the conveyor belt 18 in the dryer 3; the switchback conveyor 21 and the return conveyor 22 in the reverse conveyor 5, and some other components.

When the image input unit 202 receives information regarding an image to be printed, the main controller 201 transmits a control signal to the liquid discharge controller 207 based on the received image information. In response to the control signal from the main controller 201, the liquid discharge controller 207 controls a discharging operation of each liquid dischargers 13.

As a result, each liquid discharger 13 discharges the liquid, thereby forming an image on the sheet S in accordance with the image information.

The image information received by the image input unit 202 is transmitted to the droplet adhesion amount calculator 203 in addition to the main controller 201. The droplet adhesion amount calculator 203 calculates the amount (droplet adhesion amount) of liquid droplets to be placed on the sheet S which is necessary to form the image, based on the image information from the image input unit 202. The main controller 201 transmits a control signal to the drying controller 209 based on the droplet adhesion amount obtained from the droplet adhesion amount calculator 203 and the sheet information obtained from the sheet information input unit 205. In response to the control signal from the main controller 201, the drying controller 209 controls drying strength of each drying unit 23. In the present embodiment, for example, the drying controller 209 controls the intensity of the ultraviolet rays emitted from the ultraviolet irradiator. The amount of heat and time necessary to dry the inks depends on the amount of inks discharged onto the sheet S, a surface material of the sheet S, and some other factors. Therefore, based on the droplet adhesion amount obtained from the droplet adhesion amount calculator 203 and the sheet information obtained from the sheet information input unit 205, the main controller 201 determines ease of drying the inks. The drying controller 209 then controls the drying strength of the drying unit 23 in accordance with the determined ease, thereby performing an appropriate drying process.

### [Configuration of Dryer]

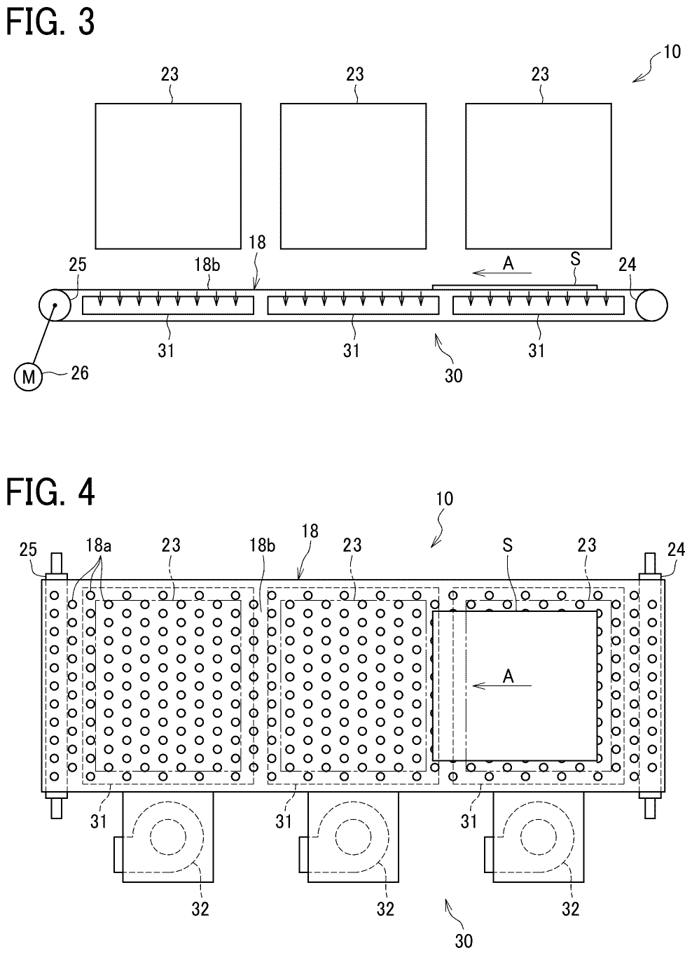

Next, a configuration of the drying device 10 according to the first embodiment of the present embodiment will be described in detail with reference to FIGS. 3 and 4.

As illustrated in FIG. 3, the drying device 10 according to the first embodiment of the present embodiment includes, in addition to the drying units 23 and the conveyor belt 18, an upstream support roller 24, a downstream support roller 25, a belt drive motor 26, and an absorber 30.

The conveyor belt 18, which forms an endless loop, is supported by the upstream support roller 24 and the downstream support roller 25 while strung therebetween. The upstream support roller 24 is a driven roller that is disposed upstream of the drying units 23 in a sheet conveyance direction A and supports the conveyor belt 18 from an inner side thereof. The downstream support roller 25 is a drive roller that is disposed downstream of the drying units 23 in the sheet conveyance direction A and supports the conveyor belt 18 from the inner side. When the downstream support roller 25 is driven to rotate in response to the driving of the belt drive motor 26, the conveyor belt 18 also rotates, conveying the sheet S placed on the conveyor belt 18 in the sheet conveyance direction A.

The absorber 30 adsorbs the sheet S onto the conveyor belt 18. As illustrated in FIG. 4, the absorber 30 includes multiple suction members 31 and multiple negative pressure generators 32. Each of the suction members 31 is a member that is disposed on the inner side of the conveyor belt 18 and inhales air through multiple suction holes 18a provided on the conveyor belt 18. Each of the negative pressure generators 32 is a section that generates negative pressure by which air is to be sucked into the suction member 31. The negative pressure generators 32 are coupled to the respective suction members 31 via airways, such as ducts, for example, and disposed on the outer side of the conveyor belt 18. The negative pressure generator 32 may be implemented by a fan or a blower, for example. When the negative pressure generator 32 generates the negative pressure inside the suction member 31, the air is inhaled through the suction hole 18a on the upper surface of the conveyor belt 18. This inhaled air causes the sheet S to be absorbed onto the upper surface of the conveyor belt 18.

The drying units 23 are arranged side by side in the sheet conveyance direction A while facing a sheet absorption surface 18b of the conveyor belt 18, which corresponds to an upper surface thereof. When the sheet S is conveyed while absorbed onto the sheet absorption surface 18b, the sheet S sequentially passes through the drying units 23 from the upstream side in the sheet conveyance direction A. At this time, the sheet S is subjected to the drying process by each drying unit 23.

In the first embodiment of the present embodiment, the multiple suction members 31 is also provided in relation to the respective drying units 23. More specifically, the multiple the suction members 31 is arranged side by side in the sheet conveyance direction A so as to face the corresponding drying units 23 with the conveyor belt 18 therebetween. In addition, the multiple negative pressure generators 32 is provided in relation to the suction members 31.

[Disadvantage with Drying Device in a Comparative Example]

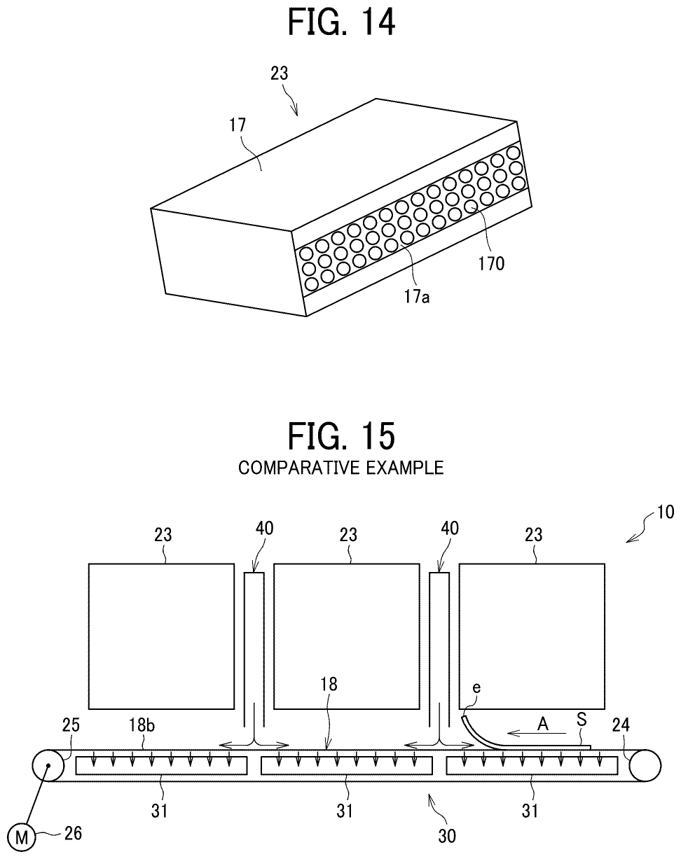

Some disadvantages with a drying device in the comparative example is described below with reference to FIG. 15.

As illustrated in FIG. 15, when the sheet S is conveyed while absorbed onto the conveyor belt 18, the sheet S is sequentially subjected to drying processes by the multiple drying units 23, so that the drying of the ink on the sheet S is accelerated. In this case, the sheet S is heated through the drying processes while the sheet S is being conveyed to the downstream side. As a result, the sheet S may be warped. When the sheet S is warped, a gap is created between the sheet S and the conveyor belt 18. This gap may hinder the sheet S from being appropriately absorbed onto the conveyor belt 18.

When disposed on the inner side of the conveyor belt 18, the suction members 31 cannot advantageously be positioned near both the upstream support roller 24 and the downstream support roller 25. Thus, it is difficult to sufficiently reserve the suction forces generated by the suction members 31 near the upstream support roller 24 and the downstream support roller 25. To reduce varying tension of the conveyor belt 18, for example due to dimensional tolerance of the conveyor belt 18, at least one of the upstream support roller 24 or the downstream support roller 25 is typically movable in directions toward and away from the other roller. Thus, the suction members 31 have to be positioned with a space (interval) reserved between the upstream support roller 24 and the corresponding suction member 31 or between the downstream support roller 25 and the corresponding suction member 31. It is thereby possible to suppress interference between the upstream support roller 24 and the corresponding suction member 31 or between the downstream support roller 25 and the corresponding suction member 31. However, it is difficult to position the suction members 31 near the upstream support roller 24 or the downstream support roller 25. This difficulty disadvantageously hinders the suction members 31 from appropriately absorbing the sheet S at the position near the upstream support roller 24 or the downstream support roller 25.

As illustrated in FIG. 15, the drying device 10 can include multiple blowers 40 that blow out air to the sheet S in order to accelerate drying of the sheet S. In this configuration, each blower 40 typically blows out air to the conveyor belt 18 in a direction orthogonal to the sheet absorption surface 18b. In this case, the air flowing toward the upstream side in the sheet conveyance direction A may disadvantageously cause a leading portion e of the sheet S to float from the conveyor belt 18 or curl the leading portion e. The floating or curling of the leading portion e of the sheet might lead to a failure to appropriately convey the sheet S. To appropriately convey the sheet S, it is necessary to suppress floating or curling of the leading portion e of the sheet S.

As described above, dryers in which sheets are absorbed and conveyed have some disadvantages: a sheet is warped and fails to be absorbed appropriately; a suction force is not sufficiently reserved at the position near support rollers; and the leading portion of a sheet floats or is curled by air blowing. Such disadvantages regarding adsorption failures tend to be more remarkable, in particular when a smaller sheet is conveyed. A smaller sheet covers a smaller number of suction holes 18a on the conveyor belt 18 than a larger sheet. Thus, when a smaller sheet is conveyed, it is more difficult to sufficiently reserve a negative pressure, making the risk of an absorption failure higher.

In consideration of the above fact, the first embodiment of the present embodiment employs the following measures against failures to appropriately absorb sheets. Hereinafter, a description will be given of a configuration of a characteristic portion of the drying device 10 according to the first embodiment of the present embodiment.

### [Configuration of Characteristic Portion]

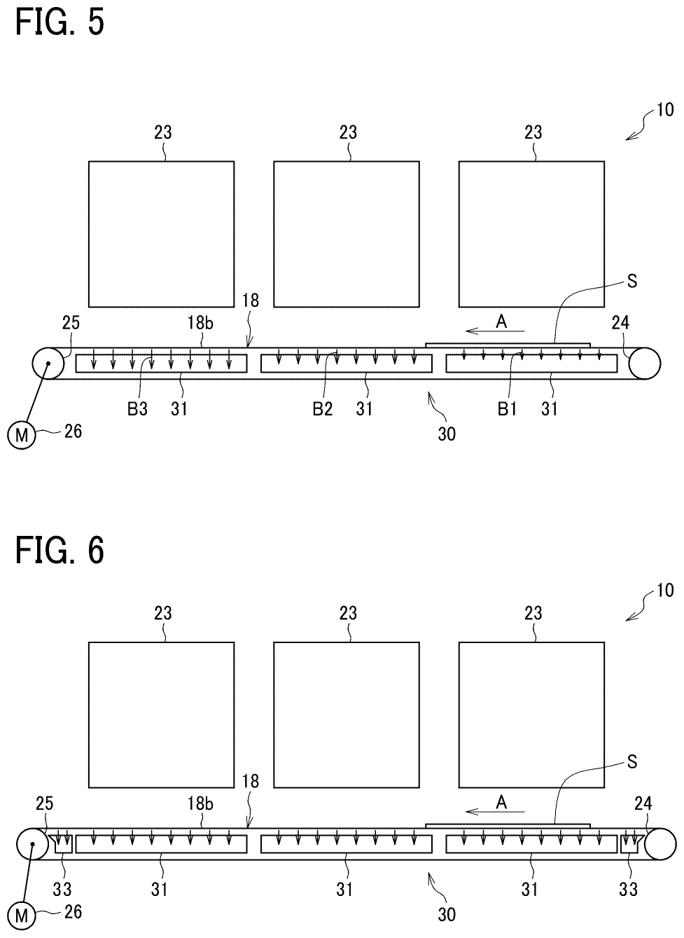

FIG. 5 is a diagram illustrating the configuration of the characteristic portion of the drying device 10 according to the first embodiment of the present embodiment.

In FIG. 5, arrows B1 to B3 indicate suction forces generated in the respective suction members 31. The length of each of the arrows B1 to B3 indicates the magnitude of the suction force. As illustrated in FIG. 5, the drying device 10 according to the first embodiment of the present embodiment is configured such that the suction force of the suction member 31 on the downstream side in the sheet conveyance direction A is larger than the suction force of the suction member 31 on the upstream side (B1<B2<B3).

The configuration, as described above, in which the suction force of the suction member 31 on the downstream side in the sheet conveyance direction A is larger than the suction force of the suction member 31 on the upstream side can appropriately absorb the sheet S even if the sheet S is warped by the heat generated during the drying process. More specifically, the sheet S is absorbed with a larger suction force on the downstream side on which the sheet S might be warped than on the upstream side in the sheet conveyance direction A This configuration can suppress creation of a gap between the sheet S and the conveyor belt 18 due to warping of the sheet S. Consequently, it is possible to appropriately absorb the sheet S onto the conveyor belt 18.

The suction forces B1 to B3 of the suction members 31 do not necessarily have to be sequentially lager toward the downstream side in the sheet conveyance direction A (B1<B2<B3). Alternatively, the suction force B3 of the suction member 31 disposed on the most downstream side in the sheet conveyance direction A may be larger than any of the suction forces B1 and B2 of the other suction members 31 on the upstream side (B1=B2<B3). In short, of the multiple suction members 31, one or some suction members 31 may generate suction forces different from the suction forces of the other suction members 31. The suction force of the suction member 31 on the most downstream side may be appropriately determined in consideration of the degree of warping of the sheet S and some other factors. The number of the suction members 31 is not limited to three and may be two or four or more instead.

To differently set the suction forces of the suction members 31, the negative pressures generated by the negative pressure generators 32 may be independently set. In addition, the suction force of each suction member 31 may be adjusted in accordance with material or rigidity of the sheet S to be conveyed.

For example, when a sheet S that resists being warped is conveyed, it is not necessary to set the suction force on the downstream side in the sheet conveyance direction A to be larger. In this case, the suction forces of all the suction members 31 may be equally set. When a warp-prone sheet S is conveyed, the suction force on the most downstream side in the sheet conveyance direction A is preferably set to be larger.

### [Configuration of Other Embodiments]

Next, subsequent to the first embodiment of the present embodiment, another embodiment will be described. Hereinafter, portions different from the portions in the first embodiment of the present embodiment will be mainly described, and descriptions of the same portions will be omitted as appropriate.

### Second Embodiment of Present Embodiment

FIG. 6 is a diagram illustrating a configuration of a characteristic portion of a drying device 10 according to the second embodiment of the present embodiment.

In the second embodiment of the present embodiment, as illustrated in FIG. 6, an absorber 30 includes, in addition to multiple first suction members 31, multiple second suction members 33, which are independent of the first suction members 31. In this case, the first suction members 31 serve as suction members that are arranged on the inner side of the conveyor belt 18 so as to face respective drying units 23 with the conveyor belt 18 therebetween, similar to the suction members 31 according to the first embodiment of the present embodiment. Of the second suction members 33, which are suction members independent of the first suction members 31, one is disposed between an upstream support roller 24 and the first suction member 31 on the most upstream side in a sheet conveyance direction A, and the other is disposed between a downstream support roller 25 and the first suction member 31 on the most downstream side in the sheet conveyance direction A.

As described above, the second suction members 33, which are independent of the first suction members 31, are arranged between the upstream support roller 24 and the first suction member 31 on the most upstream side and between the downstream support roller 25 and the first suction member 31 on the most downstream side. This arrangement can sufficiently reserve suction forces at the positions near the upstream support roller 24 and the downstream support roller 25. It is thereby possible to appropriately absorb a sheet S at the positions near both the upstream support roller 24 and the downstream support roller 25.

Since the second suction members 33 are disposed inside limited spaces between the upstream support roller 24 and the corresponding first suction member 31 and between the downstream support roller 25 and the corresponding first suction member 31, the second suction members 33 are preferably more compact than the first suction members 31. Therefore, the length of the second suction members 33 in the sheet conveyance direction A is preferably shorter than the length of the first suction members 31 in the sheet conveyance direction A. If a direction orthogonal to a sheet absorption surface 18b of a conveyor belt 18 is defined as a width direction of the first suction members 31 and the second suction members 33, the second suction members 33 is preferably the same as or smaller than the first suction members 31 in the width direction.

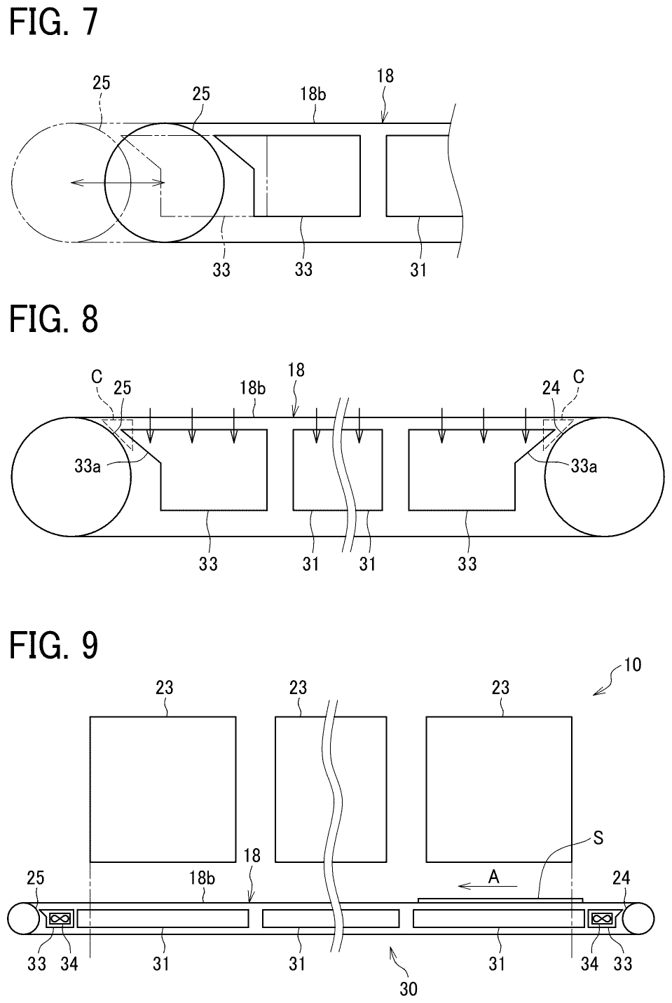

As illustrated in FIG. 7, in the second embodiment of the present embodiment, one of the second suction members 33 which is positioned nearer the downstream support roller 25 is movable together with the downstream support roller 25. As a result, the position of the second suction member 33 can be maintained near the downstream support roller 25. Even when the downstream support roller 25 is moved in the arrow directions in FIG. 7 in order to adjust the tension of the conveyor belt 18, the second suction member 33 also moves in response to the movement of the downstream support roller 25. As a result, it is not necessary to reserve a space for use in avoiding the interference between the second suction member 33 and the downstream support roller 25. The second suction member 33 thus can be disposed near the downstream support roller 25 to reserve the suction force near the downstream support roller 25. When the upstream support roller 24 functions as a tension adjusting roller instead of the downstream support roller 25, a corresponding one of the second suction member 33 is movable in response to the movement of the upstream support roller 24, so that the second suction member 33 can be disposed near the upstream support roller 24. However, the second suction members 33 do not necessarily have to be arranged near both the upstream support roller 24 and the downstream support roller 25; alternatively, a single second suction member 33 may be disposed near either one of the upstream support roller 24 and the downstream support roller 25.

In the second embodiment of the present embodiment, as illustrated in FIG. 8, each of the second suction members 33 has a sharp suction portion 33a having a wedge shape in cross section, which is formed so as to be thinner toward a corresponding one of the upstream support roller 24 and the downstream support roller 25. The sharp suction portions 33a are partly disposed into wedge-shaped gaps C between the upstream support roller 24 and the conveyor belt 18 and between the downstream support roller 25 and the conveyor belt 18 opposite the sheet absorption surface 18b of the conveyor belt 18. This arrangement enables the second suction members 33 to be disposed near both the upstream support roller 24 and the downstream support roller 25. In addition, since the sharp suction portions 33a also inhale air, the second suction members 33 can absorb a sheet S onto the sheet absorption surface 18b of the conveyor belt at lower positions with respect to both the upstream support roller 24 and the downstream support roller 25. As a result, the second suction members 33 can sufficiently generate the absorption forces near both the upstream support roller 24 and the downstream support roller 25.

In the second embodiment of the present embodiment, as illustrated in FIG. 9, the second suction member 33 on the upstream side is disposed upstream of the drying unit 23 on the most upstream side in the sheet conveyance direction A and downstream of the upstream support roller 24 in the sheet conveyance direction A. Likewise, the second suction member 33 on the downstream side is disposed downstream of the drying unit 23 on the most downstream side in the sheet conveyance direction A and upstream of the downstream support roller 25 in the sheet conveyance direction A. Moreover, the second suction members 33 on the upstream side and the downstream side are arranged so as not to face any of the drying units 23 with the conveyor belt 18 therebetween. Thus, each of the second suction members 33 is disposed under an environment that is less sensitive to the heat from the drying units 23. As opposed to the second suction members 33, the first suction members 31 are arranged so as to face the respective drying units 23 with the conveyor belt 18 therebetween. Thus, the first suction member 31 is more sensitive to the heat from the drying units 23. Therefore, each negative pressure generator 32 is disposed on the outer side of the conveyor belt 18 (see FIG. 4). If the negative pressure generators 32 are disposed inside the first suction members 31, the negative pressure generators 32 may be affected by the heat from the drying units 23, in which case some components might be damaged or have degraded functions. Therefore, each negative pressure generator 32 is disposed on the outer side of the conveyor belt 18 rather than the inner side of the first suction member 31.

Since the second suction members 33 are hardly affected by the heat from the drying units 23, the negative pressure generators 34 are disposed on the inner side of the second suction member 33, as illustrated in FIG. 9. It is thereby possible to provide a space-saving, compact drying device 10.

Each first suction member 31 includes the negative pressure generator 32, whereas each second suction member 33 includes the negative pressure generator 34. In this case, the respective suction forces of the first suction members 31 and the second suction members 33 can be set independently of one another. For example, the suction force of the second suction member 33 on the downstream side may be set so as to be larger than any of the suction forces of the first suction members 31 and the second suction member 33 on the upstream side, so that the suction force on the downstream side in the sheet conveyance direction A can be appropriately reserved.

### Third Embodiment of Present Embodiment

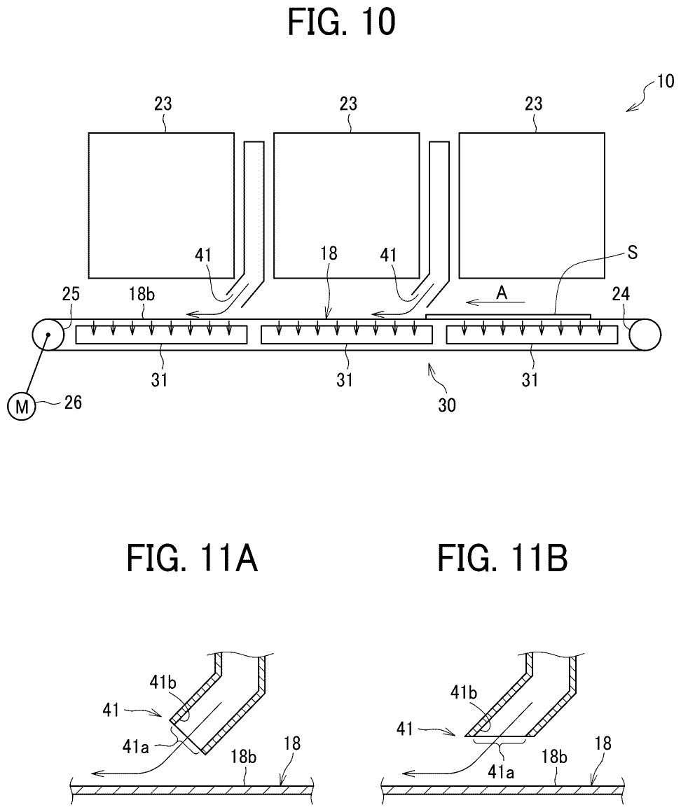

FIG. 10 is a diagram illustrating a configuration of a characteristic portion of a drying device 10 according to a third embodiment of the present embodiment.

As illustrated in FIG. 10, the drying device 10 according to the third embodiment of the present embodiment includes multiple blowers 40 that blow out air to a sheet S. Each blower 40 may be implemented by a fan or an air-blower, for example. Each blower 40 blows out air to the sheet S absorbed onto the conveyor belt 18, thereby accelerating drying of the sheet S.

Each blower 40 has an air-blowing port 41 disposed so as to face toward the downstream side in the sheet conveyance direction A. In the third embodiment of the present embodiment, as opposed to the example illustrated in FIG. 15, each air-blowing port 41 faces the sheet absorption surface 18b while the air-blowing port 41 is inclined toward the downstream side with respect to the direction perpendicular to the sheet absorption surface 18b, rather than facing in the direction perpendicular to the sheet absorption surface 18b of the conveyor belt 18.

As described above, each blower 40 has the air-blowing port 41 disposed so as to face toward the downstream side in the sheet conveyance direction A. The air is thereby blown from each blower 40 toward the downstream side in the sheet conveyance direction A via the respective air-blowing ports 41.

As a result, a smaller volume of air can be blown toward the upstream side in the sheet conveyance direction A, thus suppressing floating or curling of a leading portion of the sheet S which is caused by the air being blown to the leading portion of the sheet S. In this case, the air is blown to a trailing portion of the sheet S. However, even if the trailing portion of one sheet S floats or is curled and is caught by one of the drying units 23, for example, this catching is released along with the conveyance of the sheet S, so that a failure to appropriately convey the sheet S is less likely to occur.

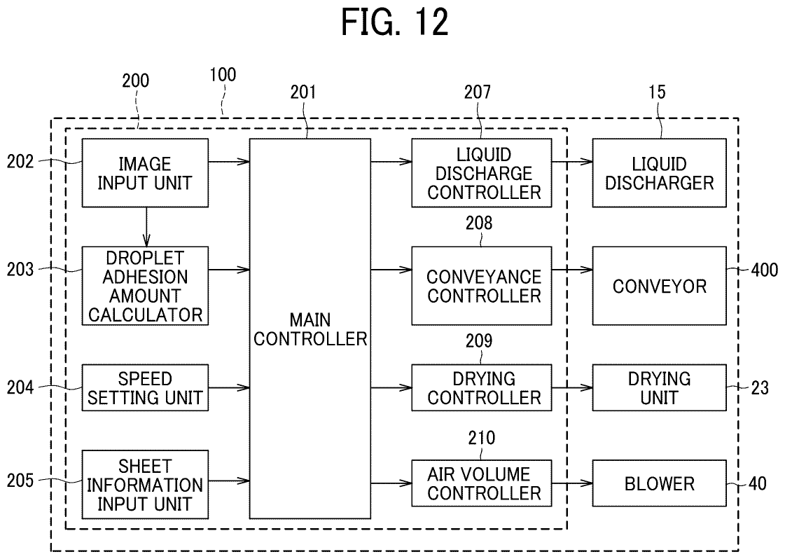

The direction in which an air-blowing port 41 refers to the direction in which a ventilation path 41b disposed near an opening 41a extends, rather than the direction in which the opening 41a faces, as illustrated in FIG. 11A or 11B. It should be noted that the openings 41a in FIGS. 11A and 11B face in different directions; however, both the ventilation paths 41b disposed near the openings 41a in FIGS. 11A and 11B extend toward the downstream side in the sheet conveyance direction A, which means that both the air-blowing ports 41 in FIGS. 11A and 11B also face toward the downstream side in the sheet conveyance direction A.

The number of blowers 40 may be either plural or one. When multiple blowers 40 is provided, the blowers 40 may blow out air in either different volumes or the same volume. The volume of air from each blower 40 may be adjusted in accordance with rigidity of the conveyed sheet S. For example, when a thin sheet, or a less rigid sheet, is conveyed, each blower 40 may blow out a smaller volume of air than when a rigid sheet is conveyed. It is thereby possible to reliably suppress the sheet S from floating or being curled by the air blowing.

The rigidity of the sheet S correlates with a basis weight, which is defined as a mass per unit area of the sheet. The volume of air to be blown thus may be varied in accordance with the basis weight.

For the purpose of varying the volume of air, as illustrated in FIG. 12, a controller 200 in a liquid discharge apparatus 100 includes an air volume controller 210 that controls the volume of air from each blower 40, based on the basis weight of the sheet S obtained from a sheet information input unit 205.

The air volume controller 210 sets the maximum output (100%) of each blower 40 to the maximum current value supplied thereto or the maximum rotation speed of the fan, for example, and varies the ratio (duty ratio) of the output of each blower 40 to the maximum output, thereby controlling the volume of air. The maximum output of the volume of air is set to, for example within the range of 3.0 m³/min or more and 4.0 m³/min or less.

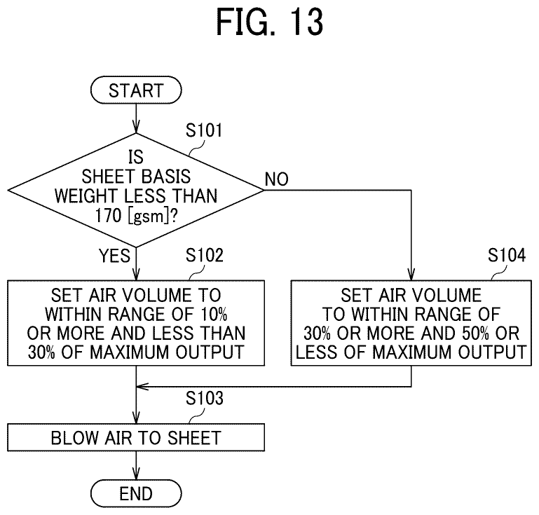

FIG. 13 is a flowchart of an example of a control flow to control the volume of air. As illustrated in FIG. 13, when the printing operation starts, it is first determined whether the basis weight of the sheet S is less than 170 gsm. This determination is made by a main controller 201, which has acquired information regarding the basis weight of the sheet S from the sheet information input unit 205. When it is determined that the basis weight is less than 170 gsm (YES in FIG. 13), the volume of air is set to within the range of 10% or more and less than 30% of the maximum output. When it is determined that the basis weight is 170 gsm or more (NO in FIG. 13), the volume of air is set to within the range of 30% or more and 50% or less of the maximum output. The setting of the volume of air in each case is made by the air volume controller 210, which has received a control signal from the main controller 201. Then, when the sheet is conveyed to a position facing each blower 40, each blower 40 blows out a set volume of air to the sheet S.

As described above, when the basis weight of the sheet S is less than 170 gsm, namely, when the sheet S has low rigidity, each blower 40 blows out a relatively small volume of air to the sheet S, thereby successfully suppressing the sheet S from floating or being curled. When the basis weight is 170 gsm or more, each blower 40 blows out a relatively large volume of air the sheet S, thereby successfully accelerating the drying of the sheet S.

The value of the basis weight to be used as a determination reference for controlling the volume of air is not limited to 170 gsm and can be set as appropriate in accordance with the type of sheet S, for example. Likewise, the volume of air to be set can also be set in any manner.

As described above, according to the embodiments of the present embodiment, sheets can be appropriately absorbed and conveyed. It is thereby possible to improve a failure to appropriately absorb the sheets. The configurations according to the embodiments may be implemented independently of one another; alternatively, two or more of the configurations may be combined together and implemented.

Herein, examples of the liquid discharge apparatus according to the present embodiment include an inkjet image-forming apparatus, which is an example of a liquid discharge apparatus, as well as some other liquid discharge apparatuses that include a liquid discharger to be driven to discharge a liquid onto a sheet S. Therefore, the liquid discharge apparatus according to the present embodiment is not limited to one that discharges liquid to visualize significant images, such as letters and figures. Examples of the liquid discharge apparatus include an apparatus that forms patterns, for example, representing no meaning, an apparatus that forms three-dimensional images, and a process liquid discharge apparatus that discharges a process liquid onto a surface of a sheet for the purpose of modifying the surface of the sheet.

The liquid discharge apparatus according to the present embodiment may be installed in a unit related to feeding, conveying, and discharging of a sheet and a post-processing apparatus, as well as a pre-processing apparatus. Furthermore, the liquid discharge apparatus may be configured such that a liquid discharger is movable relative to a sheet or is stationary. Specific examples of the liquid discharge apparatus include: a serial type of liquid discharge apparatus in which a liquid discharge head (liquid discharger) is moveable; and a line type of liquid discharge apparatus in which a liquid discharge head (liquid discharger) is stationary.

The sheet onto which a liquid is to be discharged includes: a sheet to which a liquid can at least temporarily adhere; a sheet to which an adhering liquid can be fixed; and a sheet which an adhering liquid can permeate. Specific examples of the sheet include recording media, such as paper, recording paper, recording paper, a film, and cloth, and electronic substrates. The material of the sheet may be any material, such as paper, thread, fiber, cloth, leather, metal, plastic, glass, wood, or ceramics, to which a liquid can at least temporarily adhere.

The liquid to be discharged by the liquid discharge apparatus is not particularly limited and may be a liquid having viscosity or surface tension that is high enough for a liquid discharger to discharge the liquid; however, the viscosity of the liquid is 30 mPa's or less under normal temperature and normal pressure or adjusted to 30 mPa's or less through a heating or cooling process. More specifically, examples of the liquid include a solution, a suspension, and an emulsion that contain, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant. Such a solution, a suspension, or an emulsion can be used for, for example inkjet ink, surface treatment solution, a liquid for forming components of an electronic element or a light emitting element or a resist pattern on an electronic circuit, or a material solution for three-dimensional (3D) fabrication.

Each of the drying units provided in the dryer according to the present embodiment may be implemented by an ultraviolet irradiator, for example, which are described below.

### [Configuration of Ultraviolet Irradiator]

FIG. 14 is a perspective view of an ultraviolet irradiator 17, which is an example of a drying unit 23.

The ultraviolet irradiator 17 includes multiple light sources, each of which is preferably a light emitting diode (LED): among such LEDs, a light emitting diode (UV-LED) that emits ultraviolet light is preferable. The ultraviolet irradiator 17 illustrated in FIG. 14 has an irradiation surface 17a on which multiple UV-LEDs 170 having a grain shape is arrayed. The UV-LEDs 170 emit light of the same illuminance, thereby uniformly emitting light as a whole from the irradiation surface 17a. If being implemented by an LED, the light source can provide light with a single sharp wavelength peak and thus involves using no wavelength cut filters, as opposed to metal halide lamps, for example. It is therefore possible to reduce nonuniform progress of the drying process which is caused by the color difference between the inks.

The ultraviolet light (UV light) emitted from the ultraviolet irradiator 17 preferably has a peak wavelength of 300 nm or more and 400 nm or less. The wavelength distribution of the ultraviolet light is not particularly limited and can be appropriately varied. For example, the full width at half maximum (FWHM) of the wavelength peak may be about 15 nm.

### [Ink]

Next, the inks used in the present embodiment will be described. However, the inks are not limited to the following ink.

Each ink contains a liquid composition primarily formed of water, an organic solvent, or both water and an organic solvent.

An ink containing such a liquid composition can also be referred to as an aqueous ink. The liquid composition may contain an ultraviolet polymerization initiator and an ultraviolet polymerizable compound; however, if the liquid composition may contain an ultraviolet polymerization initiator and an ultraviolet polymerizable compound, the contents of the ultraviolet polymerization initiator and the ultraviolet polymerizable compound are set to be less than predetermined amounts. Therefore, even if the ultraviolet irradiator 17 irradiates the ink in which the contents of the ultraviolet polymerization initiator and the ultraviolet polymerizable compound are less than the predetermined amounts with the ultraviolet light, the curing due to the polymerization reaction does not occur or hardly occurs.

If a UV-curable material, such as a UV ink, containing predetermined amounts or more of ultraviolet polymerization initiator and ultraviolet polymerizable compound is irradiated with ultraviolet rays, the initiator in a radical or cationic active state reacts with the ultraviolet polymerizable compound, so that the ultraviolet polymerizable compound undergoes a polymerization reaction and is cured as a resin. As a result, the ink is fixed to the sheet. However, when a UV-curable material is used, a substance in an active state of radicals or cations may slightly remain in the printed image after the curing, disadvantageously hindering a printed matter having safety from being obtained easily.

In addition, the initiator and the polymerizable compound are expensive, which causes another disadvantage that the running cost increases.

Therefore, by using inks having low contents of the ultraviolet polymerization initiator and the ultraviolet polymerizable compound, highly safe printed matters can be obtained at a low running cost.

### [Liquid Composition]

Next, the liquid composition contained in each ink will be described. However, the liquid composition is not limited to the following liquid composition.

The liquid composition contains water or an organic solvent and, as necessary, contains other components such as a coloring material and a resin. The liquid composition may contain an ultraviolet polymerization initiator and an ultraviolet polymerizable compound.

The liquid composition can be used as, for example a coloring ink, a pre-process liquid (undercoat liquid), or a post-process liquid (protector coating liquid).

### Ultraviolet Polymerization Initiator and Ultraviolet Polymerizable Compound

The liquid composition may contain an ultraviolet polymerization initiator and an ultraviolet polymerizable compound; however, if the liquid composition contains an ultraviolet polymerization initiator and an ultraviolet polymerizable compound, the contents of the ultraviolet polymerization initiator and the ultraviolet polymerizable compound are set to be less than predetermined amounts. In this case, even when the ultraviolet irradiator irradiates the liquid composition with ultraviolet rays, the curing due to the polymerization reaction does not occur or hardly occurs.

When the liquid composition contains the ultraviolet polymerization initiator and the ultraviolet polymerizable compound, the content of the ultraviolet polymerization initiator in the liquid composition is less than 0.1% by mass, or the content of the ultraviolet polymerizable compound in the liquid composition is less than 5% by mass. If the liquid composition contains 0.1 mass % or more of ultraviolet polymerization initiator and 5 mass % or more of ultraviolet polymerizable compound, the cost may increase, and it is difficult to obtain highly safe printed matters.

Examples of the ultraviolet polymerization initiator include the ultraviolet polymerization initiator capable of generating an active species such as a radical or a cation by ultraviolet rays (UV rays) and initiating polymerization of a polymerizable compound (monomer or oligomer). As such the ultraviolet polymerization initiator, a known radical polymerization initiator, a known cationic polymerization initiator, a known base generator, or the like may be used alone or in combination of two or more.

Specific examples of the radical polymerization initiators include aromatic ketones, acylphosphine oxide compounds, aromatic onium salt compounds, organic peroxides, thio compounds (e.g., thioxanthone compounds and thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

The ultraviolet polymerizable compound is not particularly limited and can be appropriately changed. For example, a known polymerizable compound can be used. The polymerizable compound may be a monomer or an oligomer. Examples of the polymerizable compound include methacrylic acid.

### [Water]

The content of the organic solvent in the liquid composition is not particularly limited and may be appropriately selected depending on the intended purpose; however, the content is preferably 10% by mass or more and 90% by mass or less, more preferably 20% by mass or more and 60% by mass or less, from the viewpoint of drying properties and discharge reliability.

### [Organic Solvent]

The organic solvent used in the present disclosure is not particularly limited, and a water-soluble organic solvent can be used. Examples of water-soluble organic solvents include polyols, ethers (e.g., polyol alkyl ethers and polyol aryl ethers), nitrogen-containing heterocyclic compounds, amides, amines, and sulfur-containing compounds.

Specific examples of the polyols include ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol.

Examples of the polyol alkyl ethers include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Examples of polyol aryl ethers include ethylene glycol monophenyl ether and ethylene glycol monobenzyl ether.

Examples of nitrogen-containing heterocyclic compounds include 2-pyrrolidone, N-methyl-2-pyrrolidone, N-hydroxyethyl-2-pyrrolidone, 1,3-dimethyl-2-imidazolidinone, ε-caprolactam, and γ-butyrolactone.

Examples of the amides include formamide, N-methylformamide, N,N-dimethylformamide, 3-methoxy-N, N-dimethylpropionamide, and 3-butoxy-N, N-dimethylpropionamide.

Examples of amines include monoethanolamine, diethanolamine, and triethylamine.

Examples of sulfur-containing compounds include dimethyl sulfoxide, sulfolane, and thiodiethanol.

Examples of other organic solvents include propylene carbonate and ethylene carbonate.

In particular, organic solvents having a boiling point of 250° C. or less are preferred, since the organic solvents function as wetting agents and also provide good drying properties.

Preferred examples of the organic solvent further include polyol compounds having 8 or more carbon atoms and glycol ether compounds. Specific examples of the polyol compounds having 8 or more carbon atoms include 2-ethyl-1,3-hexanediol and 2,2,4-trimethyl-1,3-pentanediol.

Specific examples of the glycol ether compounds include polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyol aryl ethers such as ethylene glycol monophenyl ether and ethylene glycol monobenzyl ether.

The polyol compounds having 8 or more carbon atoms and the glycol ether compounds can improve paper-permeability of the ink when paper is used as a sheet.

The content of the organic solvent in the liquid composition is not particularly limited and may be appropriately selected depending on the intended purpose, but is preferably 10% by mass or more and 60% by mass or less, more preferably 20% by mass or more and 60% by mass or less, from the viewpoint of drying properties and discharge reliability.

### [Content of Water and Organic Solvent]

The total amount of water and organic solvent in the liquid composition is preferably 80% by mass or more, and more preferably 90% by mass or more. The liquid composition having the above content of water and organic solvent can improve the discharge performance.

### [Colorant]

The colorant is not particularly limited, and pigments and dyes can be used as the colorant.

Usable pigments include both inorganic pigments and organic pigments. Each of the pigments may be used alone or two or more of the pigments may be used in combination. In addition, a mixed crystal may be used as the pigment.

Usable pigments include black pigments, yellow pigments, magenta pigments, cyan pigments, white pigments, green pigments, orange pigments, glossy color pigments (e.g., gold pigments and silver pigments), and metallic pigments.

Specific examples of inorganic pigments include titanium oxide, iron oxide, calcium carbonate, barium sulfate, aluminum hydroxide, Barium Yellow, Cadmium Red, Chrome Yellow, and carbon black produced by a known method such as a contact method, a furnace method, and a thermal method.

Specific examples of organic pigments include azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, quinophthalone pigments), dye chelates (e.g., basic dye chelate, acid dye chelate), nitro pigments, nitroso pigments, and aniline black. Among these pigments, the pigments having good affinity for solvents are preferable. In addition, hollow resin particles and hollow inorganic particles can also be used.

Specific examples of pigments used for black-and-white printing include carbon blacks (i.e., C.I. Pigment Black 7) such as furnace black, lamp black, acetylene black, and channel black; metals such as copper, iron (i.e., C.I. Pigment Black 11), and titanium oxide; and organic pigments such as aniline black (i.e., C.I. Pigment Black 1).

Specific examples of the pigments for color include C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B (Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The dyes are not particularly limited, and acid dyes, direct dyes, reactive dyes, and basic dyes can be used. Each of such dyes can be used alone or in combination with others.

Specific examples of the dyes include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the colorant in the liquid composition is preferably 0.1% by mass or more and 15% by mass or less, more preferably 1% by mass or more and 10% by mass or less, for improving image density, fixability, and discharge stability.

Examples of the method of dispersing the pigment in the liquid composition include: a method of introducing a hydrophilic functional group to the pigment to make the pigment self-dispersible; a method of covering the surface of the pigment with a resin to disperse the pigment; and a method of dispersing the pigment by a dispersant.

Examples of the method of dispersing the pigment in the liquid composition include; a method of introducing a hydrophilic functional group to the pigment to make the pigment self-dispersible; a method of covering the surface of the pigment with a resin to disperse the pigment; and a method of dispersing the pigment by a dispersant.

Examples of the method for coating a surface of the pigment with a resin to disperse the pigment include a method for making a pigment encapsulated in a microcapsule such that the pigment can be dispersed in water. In this case, the pigment may be referred to as a resin-coated pigment. In this case, not all pigments contained in the liquid composition have to be coated with resin, and uncoated or partially coated pigments may be dispersed in the liquid composition to the extent that the effects of the foregoing embodiments are not impaired.

In the method of dispersing the pigment by a dispersant, low-molecular dispersants and high-molecular dispersants, represented by known surfactants, may be used.

More specifically, any of anionic surfactants, cationic surfactants, ampholytic surfactants, and nonionic surfactants may be used as the dispersant depending on the property of the pigment. As the dispersant, in addition to RT-100 (nonionic surfactant) manufactured by TAKEMOTO OIL & FAT Co., Ltd., a Na naphthalene sulfonate formalin condensate can also be suitably used. Each of the above dispersants may be used alone or in combination with others.

By mixing a material such as water or an organic solvent with a pigment, a liquid composition such as an ink can be obtained. The liquid composition can also be obtained by, first, preparing a pigment dispersion by mixing a pigment with water, a dispersant, etc., and thereafter mixing the pigment dispersion with other materials such as water and an organic solvent.

To obtain the pigment dispersion, water, a pigment, a pigment dispersant, and other components as necessary are mixed and dispersed and then the particle size is adjusted. The dispersion may be performed with a disperser.

The particle size of the pigment in the pigment dispersion is not particularly limited; however, the maximum frequency in terms of the maximum number is preferably 20 nm or more and 500 nm or less, and more preferably 20 nm or more and 150 nm or less, from the viewpoint of improving the dispersion stability of the pigment and improving the image quality such as ejection stability and image density. The particle diameter of the pigment can be measured with a particle size analyzer (NANOTRAC WAVE-UT151 manufactured by MicrotracBEL Corp.).

The proportion of the pigment in the pigment dispersion is not particularly limited and can be suitably selected depending on the purpose; however, the proportion is preferably 0.1% by mass or more and 50% by mass or less, more preferably 0.1% by mass or more and 30% by mass or less, in terms of improved discharge stability and image density. Preferably, the pigment dispersion is subjected to filtration using a filter or a centrifugal separator to remove coarse particles, followed by degassing.

### [Resin]

The type of resin contained in the liquid composition is not particularly limited and can be appropriately selected depending on the purpose, and examples of the resin include urethane resins, polyester resins, acrylic resins, vinyl acetate-based resins, styrene-based resins, butadiene-based resins, styrene-butadiene-based resins, vinyl chloride-based resins, acrylic styrene-based resins, and acrylic silicone-based resins.

Resin particles in these resins may be used. The resin particles may be dispersed in water as a dispersion medium to prepare a resin emulsion. The liquid composition can be obtained by mixing the resin emulsion with other materials such as a colorant and an organic solvent. The resin particles may be suitably synthesized or a commercial product. The resin particles may include one type or two or more types of resin particles.

The volume average particle diameter of the resin particles is not particularly limited and can be suitably selected depending on the purpose; however, the volume average particle is preferably from 10 nm or more and 1,000 nm or less, more preferably 10 nm or more and 200 nm or less, and particularly preferably 10 nm or more and 100 nm or less, in terms of improved fixability and image hardness. The volume average particle diameter can be measured using a particle size analyzer (NANOTRAC WAVE-UT151, product of MicrotracBEL Corp.).

The proportion of the resin in the liquid composition is not particularly limited and can be suitably selected depending on the purpose; however, the proportion is preferably 1% by mass ore more and 30% by mass or less, more preferably 5% by mass or more and 20% by mass or less, in terms of fixability and storage stability of the liquid composition.

### [Other Components]

The liquid composition may contain a surfactant, a defoamer, a preservative, a fungicide, a corrosion inhibitor, and a pH adjuster, as necessary.

### [Pre-Process Liquid (Undercoat Liquid)]

When the liquid composition is used as a pre-process liquid, the pre-process liquid contains an organic solvent and water and, as necessary, may also contain an aggregating agent, a surfactant, an antifoaming agent, a pH adjusting agent, an antiseptic and antifungal agent, or a rust inhibitor, for example. The organic solvent, the surfactant, the antifoaming agent, the pH adjusting agent, the antiseptic and antifungal agent, and the rust inhibitor may be the same materials as materials used for the liquid composition or materials used for known process liquids. The type of the aggregating agent is not particularly limited; examples of the aggregating agent include water-soluble cationic polymers, acids, and polyvalent metal salts.

### [Post-Process Liquid (Protector Coating Liquid)]

When the liquid composition is used as a post-process liquid, the post-process liquid is not particularly limited as long as a transparent layer can be formed. In addition to the organic solvent and water, the post-process liquid is obtained by selecting and mixing a resin, a surfactant, an antifoaming agent, a pH adjusting agent, an antiseptic and antifungal agent, or a rust inhibitor, for example, as necessary. The post-process liquid may be applied to an entire region of an image formed on the sheet or may be applied to a selected region of the image.

### [Curable Composition]

In the present embodiment, in addition to the liquid composition, a curable composition to be cured by ultraviolet rays may be applied to a sheet. When such a curable composition is used, the curable composition can be cured simultaneously with drying of the liquid composition by the ultraviolet irradiator. Therefore, no additional curing unit is advantageously necessary.

The curable composition can be used as a coloring ink, a white ink, a clear ink, a pre-process liquid (undercoat liquid), a post-process liquid (protector coating liquid), and some other liquids. Among those liquids, the curable composition is preferably used as a white ink or a clear ink. When a UV curable ink is used, it can also be referred to as a UV ink.

A case of using the curable composition is inferior to a cause of not using the curable composition in terms of safety and cost; however, by adding features such as white and clear a value-added printed matter can be obtained. In the present embodiment, even when the curable composition is used, a liquid composition can be used together. For example, as compared with a comparative example in which the black ink, the cyan ink, the magenta ink, the yellow ink, and the white ink are all UV curable inks, highly safe printed matters can be obtained at low running cost.

When the curable composition used is applied to a sheet at any timing before the sheet is irradiated with ultraviolet rays. In addition, this timing can be changed as appropriate. The curable composition may be applied before the application of the liquid composition to the sheet, after the application of the liquid composition to the sheet, or simultaneously with the application of the liquid composition to the sheet. A region to which the curable composition is to be applied can be changed as appropriate. For example, the region may be the same portion as an area to which the liquid composition is to be applied.

The curable composition contains a polymerization initiator and a polymerizable compound, for example and, as necessary, may further contain other components such as a coloring material and an organic solvent (organic solvent).

### [Polymerization Initiator and Polymerizable Compound]

The polymerization initiator and the polymerizable compound may be an ultraviolet polymerization initiator and an ultraviolet polymerizable compound, for example.

The polymerization initiator may be any polymerization initiator that can generate active species such as radicals or cations with ultraviolet light irradiated by an ultraviolet irradiator to initiate polymerization of a polymerizable compound (monomer or oligomer). Such a polymerization initiator may be one or a combination of two or more of a known radical polymerization initiator, a cationic polymerization initiator, and a base generator. Among them, a radical polymerization initiator is preferable. In addition, to ensure a sufficient curing rate, the polymerization initiator is preferably contained in an amount of 5 to 20 mass % with respect to the total mass (100 mass %) of the curable composition.

Specific examples of the radical polymerization initiators include aromatic ketones, acylphosphine oxide compounds, aromatic onium salt compounds, organic peroxides, thio compounds (e.g., thioxanthone compounds and thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

In addition to the polymerization initiator, a polymerization accelerator (sensitizer) may be used in combination. Examples of the polymerization accelerator include, but not particularly limited, amine compounds such as trimethylamine, methyldimethanolamine, triethanolamine, p-diethylaminoacetophenone, ethyl p-dimethylaminobenzoate, p-dimethylaminobenzoic acid-2-ethylhexyl, N, N-dimethylbenzylamine, and 4,4′-bis (diethylamino) benzophenone are preferable, and the content thereof may be appropriately set in accordance with the polymerization initiator to be used or the amount thereof.

### [Colorant]

The coloring material may be one of various pigments or dyes that impart black, white, magenta, cyan, yellow, green, orange, gold, silver, for example or a coloring material used for the liquid composition.

The content of the coloring material may be appropriately determined in consideration of a desired color density, dispersibility in the composition, and some other factors, and is not particularly limited; however, the content is preferably 0.1 to 20 mass % with respect to the total mass (100 mass %) of the curable composition. The curable composition may be colorless and transparent without containing a coloring material, in which case, for example, the curable composition is suitable as an overcoat layer (protector coat layer) for protecting an image.

### [Organic Solvent (Organic Solvent)]

The organic solvent may be an organic solvent used in the liquid composition, for example. The curable composition may contain an organic solvent, but preferably does not contain the organic solvent if possible. When the composition does not contain an organic solvent, in particular a volatile organic solvent (volatile organic compounds (VOCs) free), the safety of a place where the composition is handled is further enhanced, and it is also possible to prevent environmental pollution. The organic solvent refers to a general non-reactive organic solvent such as ether, ketone, xylene, ethyl acetate, cyclohexanone, or toluene and should be distinguished from a reactive monomer. The “not containing an organic solvent” means that the organic solvent is substantially not contained, and the content of the organic solvent is preferably less than 0.1 mass %.

The other components are not particularly limited, and examples of those compounds include known surfactants, polymerization inhibitors, leveling agents, antifoaming agents, fluorescent brighteners, penetration enhancers, wetting agents (moisturizers), fixing agents, viscosity stabilizers, antifungal agents, antiseptics, antioxidants, ultraviolet absorbers, chelating agents, pH adjusters, and thickeners.

### [Preparation]

The curable composition can be prepared using the above-described various components, and the preparation means and conditions of the curable composition are not particularly limited. For example, the curable composition can be prepared by charging a polymerizable monomer, a pigment, or a dispersant, for example, into a dispersing machine such as a ball mill, a kitty mill, a disk mill, a pin mill, or a DYNO-MILL and dispersing the polymerizable monomer, the pigment. The pigment dispersion is further mixed with a polymerizable monomer, an initiator, a polymerization inhibitor, or a surfactant, for example.

### [Viscosity]

The viscosity of the curable composition may be appropriately adjusted in accordance with the application or an application unit and is not particularly limited. For example, when a discharge unit that discharges the composition via nozzles is employed, the viscosity in the range of 20° C. to 65° C., preferably the viscosity at 25° C. is preferably 3 to 40 mPa's, more preferably 5 to 15 mPas, and particularly preferably 6 to 12 mPa·s. In addition, it is particularly preferable that the viscosity range be satisfied without containing an organic solvent. The viscosity can be measured using a cone rotor (1°34′×R24) with a cone plate type rotational viscometer VISCOMETER TVE-22 L manufactured by Toki Sangyo Co., Ltd., at a rotation speed of 50 rpm, with the temperature of the constant temperature circulating water appropriately set in the range of 20° C. to 65° C. VISCOMATE VM-150 III can be used to adjust the temperature of the circulating water.

A dryer includes: a conveyor belt having a shape of an endless loop to convey a sheet in a conveyance direction; a drying unit facing an absorption surface of the conveyor belt to dry the sheet on the absorption surface; and an absorber including multiple suction members inside the endless loop of the conveyor belt, the suction members arrayed in the conveyance direction to absorb the sheet onto the absorption surface of the conveyor belt, and at least one suction member of the multiple suction members to generate a suction force different from suction forces of other suction members.

The at least one suction member generates the suction force larger than the suction forces of the other suction members, and said at least one suction member is disposed downstream from the other suction members in the conveyance direction.

A dryer includes: a conveyor belt having a shape of an endless loop to convey a sheet in a conveyance direction; a drying unit facing an absorption surface of the conveyor belt to dry the sheet on the absorption surface; and an absorber to absorb the sheet onto the absorption surface of the conveyor belt, and an upstream roller disposed inside and upstream end of the endless loop in the conveyance direction to support the conveyor belt; and a downstream roller disposed inside and downstream end of the endless loop in the conveyance direction to support the conveyor belt.

The absorber includes: a first suction member disposed: inside the conveyor belt; and opposed to the drying unit via the conveyor belt; and a second suction member disposed: inside the conveyor belt; and between the first suction member and the downstream roller in the conveyance direction.

The dryer includes: a third suction member disposed: inside the conveyor belt; and between the first suction member and the upstream roller in the conveyance direction.

The second suction member is movable together with the downstream roller.

The second suction member has a first length shorter than a second length of the first suction member in the conveyance direction.

The second suction member includes a negative pressure generator inside the second suction member.

A dryer includes: a conveyor belt having a shape of an endless loop to convey a sheet in a conveyance direction; a drying unit facing an absorption surface of the conveyor belt to dry the sheet on the absorption surface; and an absorber to absorb the sheet onto the absorption surface of the conveyor belt; and a blower having an air-blowing port facing the absorption surface to blow air from the air-blowing port to the sheet absorbed onto the absorption surface of the conveyor belt, and the air-blowing port blows air in a blowing direction inclined toward a downstream side of the conveyor belt with respect to a direction perpendicular to the absorption surface.

A liquid discharge apparatus includes: a liquid discharger to discharge a liquid onto a sheet; and the dryer according to claim 1 to dry the liquid on the sheet.

A dryer includes: a conveyor belt having a shape of an endless loop to convey a sheet in a conveyance direction; a drying unit facing an absorption surface of the conveyor belt to dry the sheet on the absorption surface; an absorber to absorb the sheet onto the absorption surface of the conveyor belt; an upstream roller disposed inside and upstream end of the endless loop in the conveyance direction to support the conveyor belt; and a downstream roller disposed inside and downstream end of the endless loop in the conveyance direction to support the conveyor belt. The absorber includes: a first suction member disposed: inside the conveyor belt; and opposed to the drying unit via the conveyor belt; and a second suction member disposed: inside the conveyor belt; and between the first suction member and the upstream roller in the conveyance direction.

The dryer includes: a third suction member disposed: inside the conveyor belt; and between the first suction member and the downstream roller in the conveyance direction.

The second suction member is movable together with the downstream roller.

According to the present embodiment, the sheet can be appropriately conveyed while absorbed.

To summarize the aspects of the present embodiment described above, the present embodiment includes at least the following aspects.

### Aspect 1

According to Aspect 1, a dryer includes: a conveyor belt that conveys a sheet, the conveyor belt forming an endless loop; an absorber that absorbs the sheet onto the conveyor belt; and a drying unit that dries the sheet, the drying unit being disposed so as to face a sheet absorption surface of the conveyor belt. The absorber includes multiple suction members disposed on an inner side of the conveyor belt, the suction members being arranged side by side in a sheet conveyance direction. Of the multiple suction members, at least one suction member generates a suction force different from a suction force of another suction member.

### Aspect 2

According to Aspect 2, in the dryer of Aspect 1, of the multiple suction members, a suction member disposed on a downstream side in the sheet conveyance direction generates a suction force larger than a suction force of a suction member disposed on an upstream side in the sheet conveyance direction.

### Aspect 3

According to Aspect 3, a dryer includes: a conveyor belt that conveys a sheet, the conveyor belt forming an endless loop; an absorber that absorbs the sheet onto the conveyor belt; a drying unit that dries the sheet, the drying unit being disposed so as to face a sheet absorption surface of the conveyor belt; an upstream support roller that supports the conveyor belt from an inner side thereof, the upstream support roller being disposed upstream of the drying unit in a sheet conveyance direction; and a downstream support roller that supports the conveyor belt from the inner side, the downstream support roller being disposed downstream of the drying unit in the sheet conveyance direction. The absorber includes a first suction member and a second suction member, the first suction member being disposed on the inner side of the conveyor belt so as to face the drying unit with the conveyor belt therebetween, the second suction member being disposed downstream of the drying unit in the sheet conveyance direction and upstream of the downstream support roller in the sheet conveyance direction, the second suction member being disposed on the inner side of the conveyor belt.

### Aspect 4

According to Aspect 4, a dryer includes: a conveyor belt that conveys a sheet, the conveyor belt forming an endless loop; an absorber that adsorbs the sheet onto the conveyor belt; a drying unit that dries the sheet, the drying unit being disposed so as to face a sheet absorption surface of the conveyor belt; an upstream support roller that supports the conveyor belt from an inner side thereof, the upstream support roller being disposed upstream of the drying unit in a sheet conveyance direction; and a downstream support roller that supports the conveyor belt from the inner side, the downstream support roller being disposed downstream of the drying unit in the sheet conveyance direction. The absorber includes a first suction member and a second suction member, the first suction member being disposed on the inner side of the conveyor belt so as to face the drying unit with the conveyor belt therebetween, the second suction member being disposed upstream of the drying unit in the sheet conveyance direction and downstream of the upstream support roller in the sheet conveyance direction, the second suction member being disposed on the inner side of the conveyor belt.

### Aspect 5

According to Aspect 5, in the dryer of Aspect 3, the second suction member moves together with the downstream support roller.

### Aspect 6

According to Aspect 6, in the dryer of Aspect 4, the second suction member moves together with the upstream support roller.

### Aspect 7

According to Aspect 7, in the dryer of any one of Aspects 3 to 6, a length of the second suction member in the sheet conveyance direction is shorter than a length of the first suction member in the sheet conveyance direction.

### Aspect 8

According to Aspect 8, in the dryer of any one of Aspects 3 to 7, the second suction member includes a negative pressure generator inside.

### Aspect 9

According to Aspect 9, a dryer includes: a conveyor belt that conveys a sheet, the conveyor belt forming an endless loop; an absorber that absorbs the sheet onto the conveyor belt; a drying unit that dries the sheet, the drying unit being disposed so as to face a sheet absorption surface of the conveyor belt; and a blower that blows out air to the sheet absorbed onto the conveyor belt. The blower has an air-blowing port disposed so as to face toward a downstream side in the sheet conveyance direction.

### Aspect 10

According to Aspect 10, a liquid discharge apparatus includes: a liquid discharger that discharges a liquid onto a sheet; and the dryer of any one of Aspects 1 to 9 that dries the sheet with the liquid thereon.

The functionality of the elements disclosed herein such as the controller 200 may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A dryer comprising:
a conveyor belt having a shape of an endless loop to convey a sheet in a conveyance direction;
a drying unit facing an absorption surface of the conveyor belt to dry the sheet on the absorption surface; and
an absorber including multiple suction members inside the endless loop of the conveyor belt,
the suction members arrayed in the conveyance direction to absorb the sheet onto the absorption surface of the conveyor belt, and
at least one suction member of the multiple suction members to generate a suction force different from suction forces of other suction members.

2. The dryer according to claim 1,
wherein said at least one suction member generates the suction force larger than the suction forces of the other suction members, and
said at least one suction member is disposed downstream from the other suction members in the conveyance direction.

3. A dryer comprising:
a conveyor belt having a shape of an endless loop to convey a sheet in a conveyance direction;
a drying unit facing an absorption surface of the conveyor belt to dry the sheet on the absorption surface; and
an absorber to absorb the sheet onto the absorption surface of the conveyor belt, and
an upstream roller disposed inside and upstream end of the endless loop in the conveyance direction to support the conveyor belt; and
a downstream roller disposed inside and downstream end of the endless loop in the conveyance direction to support the conveyor belt,
wherein the absorber includes:
a first suction member disposed:
inside the conveyor belt; and
opposed to the drying unit via the conveyor belt; and
a second suction member disposed:
inside the conveyor belt; and
between the first suction member and the downstream roller in the conveyance direction.

4. The dryer according to claim 3, further comprising:
a third suction member disposed:
inside the conveyor belt; and
between the first suction member and the upstream roller in the conveyance direction.

5. The dryer according to claim 3, wherein the second suction member is movable together with the downstream roller.

6. The dryer according to claim 3, wherein the second suction member has a first length shorter than a second length of the first suction member in the conveyance direction.

7. The dryer according to claim 3, wherein the second suction member includes a negative pressure generator inside the second suction member.

8. A liquid discharge apparatus comprising:
a liquid discharger to discharge a liquid onto a sheet; and
the dryer according to claim 1 to dry the liquid on the sheet.

9. A dryer comprising:
a conveyor belt having a shape of an endless loop to convey a sheet in a conveyance direction;
a drying unit facing an absorption surface of the conveyor belt to dry the sheet on the absorption surface;
an absorber to absorb the sheet onto the absorption surface of the conveyor belt;
an upstream roller disposed inside and upstream end of the endless loop in the conveyance direction to support the conveyor belt; and
a downstream roller disposed inside and downstream end of the endless loop in the conveyance direction to support the conveyor belt,
wherein the absorber includes:
a first suction member disposed:
inside the conveyor belt; and
opposed to the drying unit via the conveyor belt; and
a second suction member disposed:
inside the conveyor belt; and
between the first suction member and the upstream roller in the conveyance direction.

10. The dryer according to claim 9, further comprising:
a third suction member disposed:
inside the conveyor belt; and
between the first suction member and the downstream roller in the conveyance direction.

11. The dryer according to claim 9, wherein the second suction member is movable together with the downstream roller.
